(19) United States
(12) Patent Application Publication
(10) Pub. No.: US 2018/0085790 A1
(43) Pub. Date: Mar. 29, 2018

(54) RECIPROCATING SCRAPER BLADE APPARATUS AND METHOD

(71) Applicant: Andrew Craig, New Orleans, LA (US)

(72) Inventor: Andrew Craig, New Orleans, LA (US)

(21) Appl. No.: 15/277,425

(22) Filed: Sep. 27, 2016

(51) Int. Cl. B08B 1/00; B25F 3/00

(52) U.S. Cl. CPC B08B 1/005; B23D 49/10; B25F 3/00; B08B 1/008

(57) ABSTRACT

A reciprocating scraper blade apparatus and method providing a multi-blade unit removably mounted upon a support unit that fits the receiver of a standard reciprocating saw and positions the multi-blade unit for efficient use, with a reciprocating saw, on workpieces situated in various floor, wall, and ceiling orientations, and having various corners, crevices, and grooves, allowing safe and secure placement and manipulation of the reciprocating saw in relation to the workpiece, and allowing safe and efficient scraping of the workpiece, including its corners, crevices, and grooves.

### BACKGROUND

This invention is a reciprocating scraper blade apparatus and method providing a multi-blade unit removably mounted upon a support unit that fits the receiver of a standard reciprocating saw and positions the multi-blade unit for efficient use.

In the renovation and rebuilding of homes, commercial buildings, and other structures, there is a need to remove old paint, rust, or other substances from surfaces as preparation for new applications of paint or coatings. Even in new construction, if some of the structural or decorative components are re-used or recycled from older structures, there is a need for scraping. The surfaces requiring scraping are situated in various floor, wall, and ceiling orientations, and have various corners, crevices, and grooves that can interfere with the safe and secure placement and manipulation of a scraping tool. For instance, the operator might have to work on a scaffold or ladder, or might have to kneel on a floor, and is not able to reach a far distance while still maintaining good control of the scraper.

A reciprocating saw is a standard tool found on most worksites. There are existing scraping blades for use in reciprocating saws. However, when these existing scraping blades are used in reciprocating saws in real-world circumstances, which are often awkward and difficult to manage, they are difficult to control and fail to perform the scraping efficiently. Such a setup can cause the apparatus to function as a small jackhammer if used inexpertly. Use of these existing scraper blades in reciprocating saws can result in damage to the surface, such as gouging and chipping, and can result in injury to the operator if the operator has to hold and control a shaking saw in an awkward position.

There thus is a need for a scraping blade for use with a reciprocating saw that allows the saw to be held in a safe and secure position while the scraping blades are held in the proper orientation to the scraped surface.

### SUMMARY OF THE INVENTION

This invention is a reciprocating scraper blade apparatus and method providing a multi-blade unit removably mounted upon a support unit that fits the receiver of a standard reciprocating saw, and positions the multi-blade unit for efficient use with a reciprocating saw, on workpieces situated in various floor, wall, and ceiling orientations, and having various corners, crevices, and grooves, allowing safe and secure placement and manipulation of the reciprocating saw in relation to the workpiece, and allowing for safe and efficient scraping of the workpiece, including its corners, crevices, and grooves.

This invention solves the problem of scraping surfaces that are in otherwise awkward configurations, orientations, or locations for safe and efficient use of a reciprocating saw to drive a scraper device.

### BRIEF DESCRIPTION OF DRAWINGS

Reference will now be made to the drawings, wherein like parts are designated by like numerals, and wherein:

FIG. 1 is an illustration of the reciprocating scraper blade apparatus in an as-used position, mounted on a reciprocating saw;

FIG. 2 is an above-perspective view of a preferred embodiment of the reciprocating scraper blade apparatus;

FIG. 3 is a below-perspective view of a preferred embodiment of the reciprocating scraper blade apparatus;

FIG. 4 is an above-perspective exploded view of a preferred embodiment of the reciprocating scraper blade apparatus;

FIG. 5 is a below-perspective exploded view of a preferred embodiment of the reciprocating scraper blade apparatus;

FIG. 6 is five views of the support unit of a preferred embodiment of the reciprocating scraper blade apparatus; and

FIG. 7 is four views of the multi-blade unit of a preferred embodiment of the reciprocating scraper blade apparatus.

### DETAILED DESCRIPTION OF THE INVENTION

Referring to all figures generally, a preferred embodiment of the reciprocating scraper blade apparatus 10 and method is illustrated.

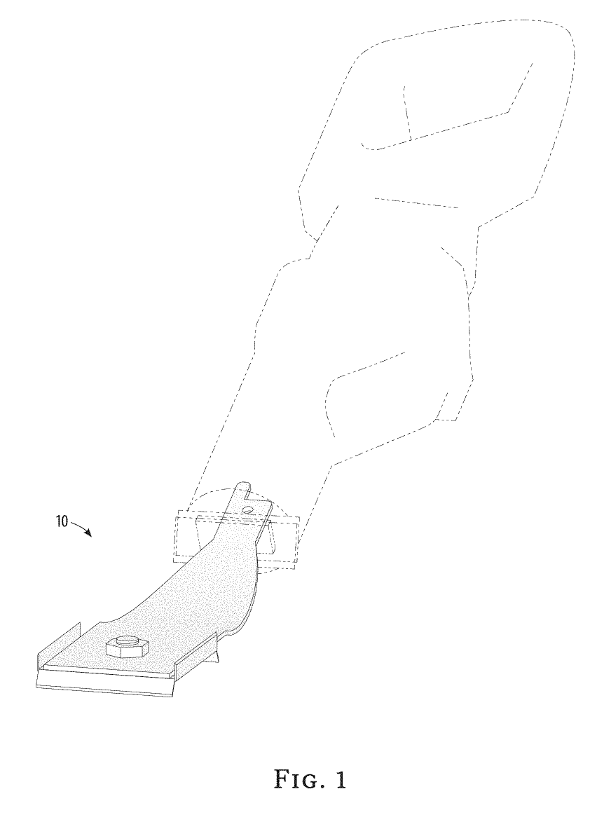

Referring to FIG. 1, the reciprocating scraper blade apparatus is meant to be mounted into the blade receiver of a standard reciprocating saw, corded or cordless. The reciprocating saw can then be held by the operator at a secure, safe angle and distance from the workpiece surface to be scraped, while the blades are positioned properly against the workpiece surface, with the proper pressure applied.

Although the use of the reciprocating scraper blade 10 is illustrated and described in relation to a horizontal and upward-facing workpiece, for the sake of clarity, the invention is equally effective on, and arguably of greater advantage on, surfaces such as walls and ceilings. In use on these surfaces, the reciprocating scraper blade 10 allows the more secure and safe positioning and manipulation of the reciprocating saw driving the reciprocating scraper blade, and more efficient and effective scraping.

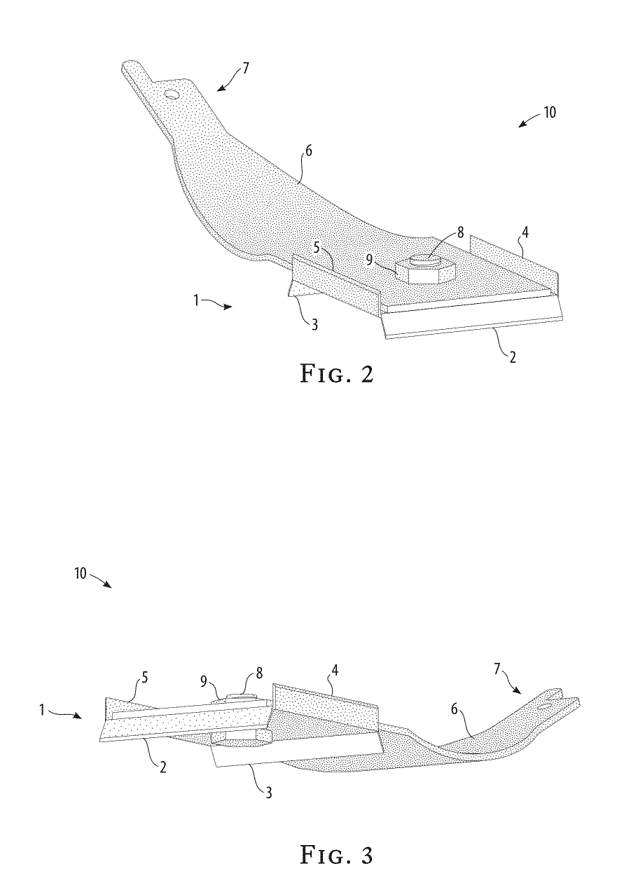

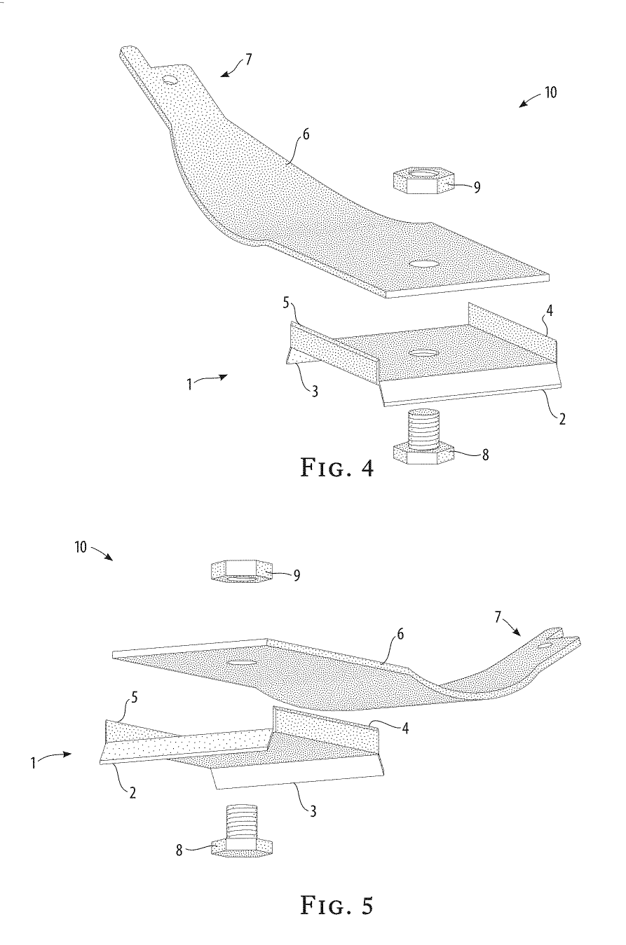

Referring to FIG. 2 & FIG. 3, assembled views, and FIG. 4 & FIG. 5, exploded views, the reciprocating scraper blade apparatus 10 provides a multi-blade unit 1 having a nominally forward downward blade 2, a rearward downward blade 3, a left upward blade 4, and a right upward blade 5. The multi-blade unit 1 is securely but removably mounted to the nominally forward underside of a support unit 6, which has a saw-mounting configuration 7 at the rearward end. The multi-blade unit 1 can be removably mounted to the support unit 6 by various kinds of fasteners known in the art. A preferred embodiment uses a standard bolt 8 and nut 9. The chosen fasteners should be capable of withstanding intense vibration in use, without uncoupling or failing. If the mounting becomes slightly loose, it does not adversely affect the operation of the reciprocating scraper blade 10 because the left and right upward blades 4, 5 encompass the support unit 6 and prevent significant rotation of the multi-blade unit 1. Under some scraping conditions, it might be desired to set the mounting slightly loose and use the slight rotational play to an advantage. In other scraping conditions, if desired to set the mounting in a tighter fashion, a standard washer and lock washer may also be used for additional stability.

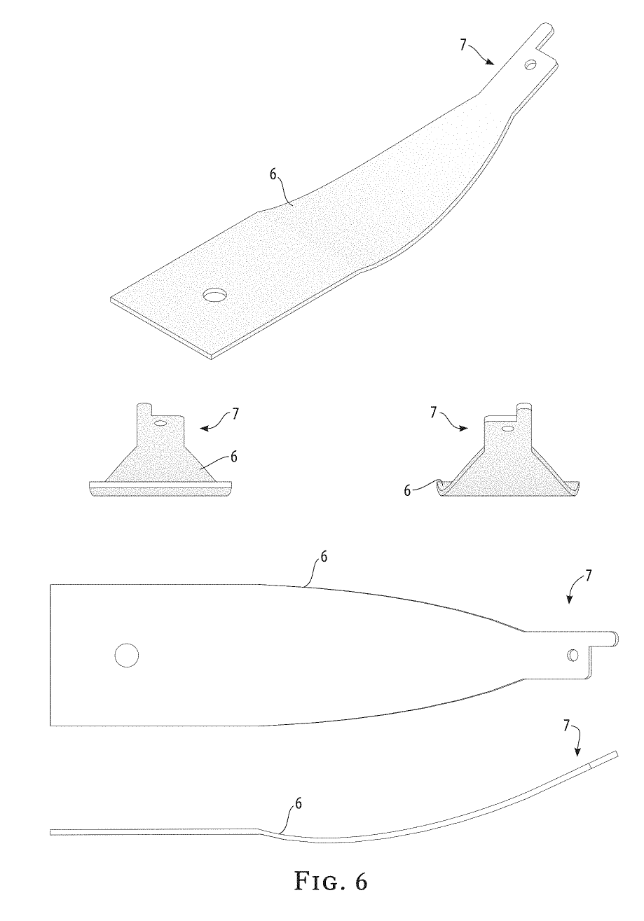

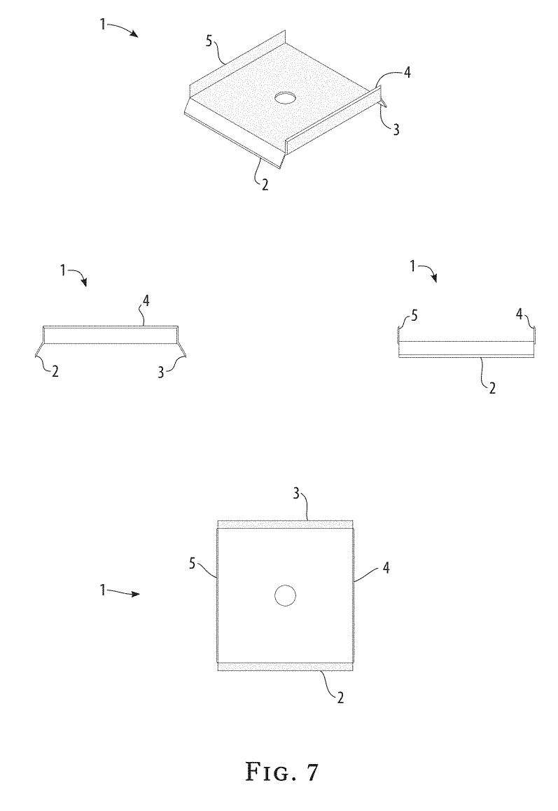

Referring also to FIG. 6, the support unit 6 has at the nominally rearward end a saw-mounting configuration 7, which essentially matches the size and shape of the mounting ends of standard reciprocating-saw blades, which are, within tolerances, 1/16″ or 1.5 mm thick, ½″ or 13 mm wide, with a 5/32″ or 4 mm diameter hole and a 5/32″ or 4 mm wide tab extending 5/16″ or 8 mm from the end, as shown, and as known in the art. In a preferred embodiment, the entire support unit is 1/16″ or 1.5 mm thick and is made out of steel, although another metal or a sufficiently tough plastic or composite could also be used. The support unit is approximately 5.5″ or 14 cm long and 1.5″ or 4 cm maximum width, tapering in width from the maximum at the forward end to the standard ½″ or 13 mm at the rearward end saw-mounting configuration, as shown. The tapering portion of the body of the support unit is bent on a 25″ radius, which places the forward, blade-mounting surface and the rearward, saw-mounting surface at a 25-degree angle to each other. This gradual bending of the support unit 6 places the multi-blade unit at advantageous angles to both the reciprocating saw and the workpiece to be scraped. The reciprocating saw can be held in a secure, safe, comfortable position, which would otherwise be ineffective and damaging with a straight scraper assembly, while the multi-blade unit 1 here is moved into proper position to address the workpiece. The gradual bending of the support unit 6 also provides a proper amount of springiness that is additionally advantageous in use. This springiness also reduces any tendency of the scraper to gouge or chip if accidentally used at a wrong, or jackhammer-like, angle.

Referring also to FIG. 7, a preferred embodiment of the multi-blade unit 1 is made from a single steel plate, 3/64″ to 1/16″ or 1 mm to 1.5 mm thick, with a starting size approximately 2″ or 4 cm square, from which individual blades 2, 3, 4, 5 are bent either up or down as appropriate, the individual blades being approximately ¼″ or 6 mm from the bend to the edge. This results in an approximately 1.5″ or 4 cm square flat area in the center. Although the exact dimensions of the support unit 6 and of the multi-blade unit 1 are not critical, it is important that the width separating the upward blades 4, 5, which is the width of the square flat center area of the multi-blade unit 1, is not smaller than the maximum width of the support unit 6. Otherwise the upward blades 4, 5 will prevent the multi-blade unit 1 from being properly mounted upon the support unit 6. The forward downward blade 2 and the rearward downward blade 3 are optimally bent downward angle of about 60-degrees to 70-degrees. A working prototype of the preferred embodiment uses an angle of 65-degrees. The left upward blade 4 and the right upward blade 5 are bent at an approximately 90-degree, or right, angle. The long edges of all four blades are sharpened for scraping. Additionally, both short edges of both upward blades 4, 5, or four short edges total, are sharpened, as shown. The three edges of each upward blade 4, 5 come into play when scraping corners, crevices, and grooves.

In use, all four of the blades contribute to the scraping process, and are applied to the workpiece at optimum angles and optimum pressure because of the springy bend in the support unit 6. With the plane of the center flat area of the multi-blade unit 1 held essentially parallel to the surface or main surface of the workpiece, the forward downward blade 2 and the rearward downward blade 3 address the workpiece at an approximately 60-degree to 70-degree angle. Both downward blades perform scraping on each push stroke and each pull stroke. The left upward blade 4, and the right upward blade 5 perform scraping on surfaces generally perpendicular to the main surface, such as occur in corners, crevices, and grooves. This action is advantageous when scraping workpieces such as casings or moldings having some kind of relief, and such as weatherboard or lap siding. The sharpened short edges scrape on either the push or pull stroke, and the sharpened upward-facing edge finishes cutting any partially scraped but still-attached material, preventing the formation of long strings of such material, and reducing the risk of shaving an unwanted long groove in the workpiece.

Although the use of the reciprocating scraper blade 10 has been illustrated and described in relation to a horizontal and upward-facing workpiece, for the sake of clarity, the invention is equally effective on, and arguably of greater advantage on, surfaces such as walls and ceilings, where the reciprocating scraper blade 10 allows the more secure and safe positioning and manipulation of the reciprocating saw driving the reciprocating scraper blade.

Many changes and modifications can be made in the present invention without departing from the spirit thereof. I therefore pray that rights to the present invention be limited only by the scope of the appended claims.

What is claimed is:

1. A reciprocating scraper blade apparatus for use, with a reciprocating saw, on workpieces situated in various floor, wall, and ceiling orientations, and having various corners, crevices, and grooves, the reciprocating scraper blade apparatus comprising:
(i) a support unit of thin sheet material having an upward face and a downward face corresponding to the broad faces of the sheet material, having at a rearward end a saw-mounting configuration adapted to be mounted into a reciprocating saw, having a planar blade-mounting surface at a forward end, and having between the forward and rearward ends a section curved such that the planes defined by the faces of the forward blade-mounting surface and of the rearward saw-mounting configuration are at an acute angle one to the other;
(ii) a multi-blade unit of thin sheet material capable of holding a sharpened edge and having an upward face and a downward face and having a frontward, rearward, left, and right orientation, removably mounted to the forward, downward face of said support unit, and having a rectangular planar center section and having a forward downward blade and a rearward downward blade, each extending downward from the center section, and a left upward blade and a right upward blade, each extending upward from the center section, where each blade has a long edge and two short edges, and where the long edges of all four blades are sharpened and the short edges of the two upward blades are also sharpened; and
(iii) a fastener adapted to removably mount said multi-blade unit to said support unit;
where, in use on workpieces situated in various floor, wall, and ceiling orientations, said reciprocating scraper blade apparatus allows safe and secure placement and manipulation of the reciprocating saw in relation to the workpiece, and allows safe and efficient scraping, including corners, crevices, and grooves, of the workpiece.

2. The reciprocating scraper blade apparatus of claim 1, where said support unit is made of sheet steel.

3. The reciprocating scraper blade apparatus of claim 1, where said multi-blade unit is made of sheet steel.

4. The reciprocating scraper blade apparatus of claim 1, where the saw-mounting configuration of said support unit has the dimensions of 1/16″ or 1.5 mm thick, ½″ or 13 mm wide, with a 5/32″ or 4 mm diameter hole and a 5/32″ or 4 mm wide tab extending 5/16″ or 8 mm from the end,

5. The reciprocating scraper blade apparatus of claim 1, where said support unit has the approximate dimensions of 1/16″ or 1.5 mm thick, 5.5″ or 14 cm long, and 1.5″ or 4 cm maximum width, tapering in width from the maximum at the forward end to the standard ½″ or 13 mm at the rearward end saw-mounting configuration.

6. The reciprocating scraper blade apparatus of claim 1, said support unit further comprising having between the forward and rearward ends a section curved on a 25″ radius, such that the planes defined by the faces of the forward blade-mounting surface and of the rearward saw-mounting configuration are at an acute angle of 25° one to the other.

7. The reciprocating scraper blade apparatus of claim 1, where said multi-blade unit is made from a single steel plate, 3/64″ to 1/16″ or 1 mm to 1.5 mm thick, with a starting size approximately 2″ or 4 cm square, and the individual blades are approximately ¼″ or 6 mm from the bend to the edge, leaving an approximately 1.5″ or 4 cm square flat area in the center.

8. The reciprocating scraper blade apparatus of claim 1, where said forward downward blade and said rearward downward blade are set an angle of 60-degrees to 70-degrees in relation to the plane of said rectangular planar center section.

9. The reciprocating scraper blade apparatus of claim 1, where said forward downward blade and said rearward downward blade are set an angle of 65-degrees in relation to the plane of said rectangular planar center section.

10. The reciprocating scraper blade apparatus of claim 1, where said left upward blade and said right upward blade are set an angle of 90-degrees in relation to the plane of said rectangular planar center section.

11. A method of using a reciprocating scraper blade, with a reciprocating saw, on workpieces situated in various floor, wall, and ceiling orientations, and having various corners, crevices, and grooves, the reciprocating scraper blade method comprising:
(i) providing a reciprocating scraper blade apparatus, comprising:
(a) a support unit of thin sheet material having an upward face and a downward face corresponding to the broad faces of the sheet material, having at a rearward end a saw-mounting configuration adapted to be mounted into a reciprocating saw, having a planar blade-mounting surface at a forward end, and having between the forward and rearward ends a section curved such that the planes defined by the faces of the forward blade-mounting surface and of the rearward saw-mounting configuration are at an acute angle one to the other;
(b) a multi-blade unit of thin sheet material capable of holding a sharpened edge and having an upward face and a downward face and having a frontward, rearward, left, and right orientation, removably mounted to the forward, downward face of said support unit, and having a rectangular planar center section and having a forward downward blade and a rearward downward blade, each extending downward from the center section, and a left upward blade and a right upward blade, each extending upward from the center section, where each blade has a long edge and two short edges, and where the long edges of all four blades are sharpened and the short edges of the two upward blades are also sharpened; and
(c) a fastener adapted to removably mount said multi-blade unit to said support unit;
(ii) mounting said reciprocating scraper blade apparatus in a reciprocating saw; and
(iii) scraping workpieces situated in various floor, wall, and ceiling orientations;
where said reciprocating scraper blade apparatus allows safe and secure placement and manipulation of the reciprocating saw in relation to the workpiece, and allows safe and efficient scraping, including corners, crevices, and grooves, of the workpiece.

12. The reciprocating scraper blade method of claim 11, where said support unit is made of sheet steel.

13. The reciprocating scraper blade method of claim 11, where said multi-blade unit is made of sheet steel.

14. The reciprocating scraper blade method of claim 11, where the saw-mounting configuration of said support unit has the dimensions of 1/16″ or 1.5 mm thick, ½″ or 13 mm wide, with a 5/32″ or 4 mm diameter hole and a 5/32″ or 4 mm wide tab extending 5/16″ or 8 mm from the end.

15. The reciprocating scraper blade method of claim 11, where said support unit has the approximate dimensions of 1/16″ or 1.5 mm thick, 5.5″ or 14 cm long, and 1.5″ or 4 cm maximum width, tapering in width from the maximum at the forward end to the standard ½″ or 13 mm at the rearward end saw-mounting configuration.

16. The reciprocating scraper blade method of claim 11, said support unit further comprising having between the forward and rearward ends a section curved on a 25″ radius, such that the planes defined by the faces of the forward blade-mounting surface and of the rearward saw-mounting configuration are at an acute angle of 25-degrees one to the other.

17. The reciprocating scraper blade method of claim 11, where said multi-blade unit is made from a single steel plate, 3/64″ to 1/16″ or 1 mm to 1.5 mm thick, with a starting size approximately 2″ or 4 cm square, and the individual blades are approximately ¼″ or 6 mm from the bend to the edge, leaving an approximately 1.5″ or 4 cm square flat area in the center.

18. The reciprocating scraper blade method of claim 11, where said forward downward blade and said rearward downward blade are set an angle of 60-degrees to 70-degrees in relation to the plane of said rectangular planar center section.

19. The reciprocating scraper blade method of claim 11, where said forward downward blade and said rearward downward blade are set an angle of 65-degrees in relation to the plane of said rectangular planar center section.

20. The reciprocating scraper blade method of claim 11, where said left upward blade and said right upward blade are set an angle of 90-degrees in relation to the plane of said rectangular planar center section.
